(19) United States
(12) Patent Application Publication
(10) Pub. No.: US 2006/0141181 A1
(43) Pub. Date: Jun. 29, 2006

(54) Glass tube for technical applications and process for the production thereof

(76) Inventors: Andreas Langsdorf, Ingelsheim (DE); Frank Buellesfeld, Frankfurt am Main (DE); Ulrich Lange, Mainz (DE); Martin Zoettl, Tiefenbach/Untergolding (DE)

Correspondence Address: STRIKER, STRIKER & STENBY, 103 EAST NECK ROAD, HUNTINGTON, NY, 11743, US

(21) Appl. No.: 11/296,798

(22) Filed: Dec. 7, 2005

(30) Foreign Application Priority Data
Dec. 14, 2004 (DE) 10 2004 060 409.6

(51) Int. Cl. C03B 9/16; C03B 29/00; B28B 11/00

(52) U.S. Cl. 428/34.4; 65/108; 65/68; 65/DIG. 9

(57) ABSTRACT

The invention relates to glass tubes for technical applications, especially for electrical or magnetic components, such as reed switches for example.

According to a first embodiment, the glass tube has an inner bore (23) and at least one cross-sectional constriction (X) whereby the relationship applicable between the respective cross-sectional constriction (X) and the diameter (d) of the circumference of inner bore (23) is: x greater than or equal to 0.02*d, more preferably x greater than or equal to 0.1*d. According to a further embodiment, the glass tube has at least one inner bore with at least one inner edge, wherein the radius of curvature of the respective inner edge is less than or equal to 0.1 mm and preferably less than or equal to 0.03 mm. The glass tube is used as a preform for a subsequent redrawing process. The preform is formed by casting a molten glass into a shaft in the interior of which is located a shaping means for defining the inner bore. In this case a gas cushion prevents direct contact of the molten glass with the inner circumferential wall of the shaft and/or the outer circumferential wall of the shaping means.

### FIELD OF THE INVENTION

The present invention relates in general to glass tubes for technical applications, especially for electrical or magnetic components, and a process for the production thereof. In particular, the present invention relates to glass tubes for use as encapsulation for what are known as reed switches.

### BACKGROUND OF THE INVENTION

Reed switches are known to be electronic switching components, the contacts of which are connected in a glass tube under a shielding gas atmosphere, an inert gas atmosphere or under vacuum and which are operated by external magnetic fields in order to perform a switching operation. For enclosure in the shielding gas atmosphere previously referred to, reed switches are usually encapsulated in a glass tube (frequently also referred to as a “reed tube” or “reed glass”) the ends of which ate appropriately sealed off.

Reed switches of the type referred to above are used in large numbers wherever low switching capacity, high levels of safety and accuracy are required. The contacts work in an inert or reducing atmosphere in order to guarantee a high level of reliability and a long service life in excess of 10⁹ cycles of operation. The atmosphere in the interior of the switch is retained during its entire service life due to the hermetic bond between the contacts (reeds) and the enveloping glass tube. This requirement precludes sealing by means of a gas flame. In addition to electric Pt/Rh heating coils which are still used here and there, nowadays sealing is largely accomplished with tungsten halogen lamps, which focus the infrared radiation onto the sealing area by means of gold-coated reflectors, or with Nd:YAG lasers.

Reed tubes are usually produced by direct drawing from a glass melt, for example using the conventional Vello process, the Danner process or appropriate downdraw processes. Of special significance are the glass stresses at the sealing points of reed switches, that is, at the glass to metal transitions after sealing in the contacts. Whilst one normally seeks to prevent glass stresses in glass to metal fusions by means of careful cooling, the reed seals are cooled down rapidly to achieve higher throughput rates or lower unit costs (shorter cycle times), whereby a complex stress pattern is purposely built up.

The important thing here is a radial compressive stress of sufficient magnitude which in this case ensures hermetic sealing or encapsulation and adequate mechanical stability of the seal. At the same time, unavoidable axial and tangential tensile stresses arise which lead to crack formation and thus to destruction of the switch if a critical value is exceeded.

EP 1 153 895 A1 discloses a glass tube of a glass with a high absorbency in the infrared spectral range for use as encapsulation for reed switches. The high absorbency facilitates encapsulation within a short time by means of infrared radiation whereby the probability of condensing gas vapours forming a coating on the inside of the glass tube, which might otherwise lead to faulty electrical contacts, is reduced by the glass composition chosen. The transmittancy with a wavelength of 1050 nm is less than 10% for a thickness of the glass wall of 0.5 mm.

U.S. Pat. No. 4,277,285 discloses a glass composition for reed tubes with an absorbency of at least 98% in the infrared spectral range between approximately 700 nm and 4000 nm, whereby an average thermal expansion coefficient in the temperature range between 20° C. and 300° C. is approximately 9×10⁶/° C. and whereby the glass is less viscous, in order to reduce the probability of faulty contacting due to condensing glass vapours. The composition of the glass contains substantially no K₂O and no B₂O₃.

DE 37 20 526 A1 (corresponding to U.S. Pat. No. 5,080,705) discloses a method and an apparatus for producing profiled glass tubing utilizing the Danner process. This document discloses profiled glass tubings of a non-circular cross section having a radius of as low as 0.1 mm. This document relates to the production of general-purpose glass tubings, but not to glass tugings for use as tubes for encapsulating electrical or magnetic elements.

DE 23 33 495 C3 discloses a method for producing glass tubes using a redrawing process from a glass perform. A resistive coating of carbon is applied onto the inner circumferential wall of the glass tube in order to provide a resistive element. Accordingly, the glass tube is not used for encapsulating electrical or magnetic components.

Thus conventional reed tubes always have a round geometry and are produced from special types of glass such as those disclosed in U.S. Pat. No. 4,277,285 and EP 1 153 895 A1. Such glass tubes and other glass tubes which are used in magnetic and electrical applications (e.g. diodes) are also usually produced directly from the melt by a drawing process, for example by means of a conventional Vello, Danner or downdraw process.

### SUMMARY OF THE INVENTION

The object of the present invention is to provide a glass tube for technical applications, especially for electrical or magnetic components, for example for electronic components, with which it is possible to achieve encapsulations of the type referred to above more reliably, more easily and more cost-effectively. A further aspect of the present invention relates to a corresponding production process.

According to a first aspect of the present invention, a glass tube for technical applications is provided, especially for electrical or magnetic components, with an inner bore and at least one cross-sectional constriction narrowing the profile of the inner bore, whereby the relationship applicable between the relevant cross-sectional constriction (x) and the diameter (d) of the inner bore's circumference is: x greater than or equal to 0.02*d; and whereby the relationship applicable between the relevant cross-sectional constriction (x) and the diameter (d) of the inner bore's circumference is: x greater than or equal to 0.1*d.

As a result of the cross-sectional constriction, the time required when sealing off a reed tube so that the tube walls of a glass tube substantially heated up to a melting temperature come into mutual contact and can fuse with one another is advantageously reduced. As a result of the cross-sectional constriction it is possible to effectively reduce or selectively increase glass stresses in glass to metal fusions which provides for a lower rejection rate in technical applications, such as reed switches for example, and more reliable continuous operation as the danger of crack formations is effectively reduced. Moreover, the cross-sectional constrictions serve as geometry-defining installation aids for the reed contacts.

According to a further embodiment, the inner bore has a substantially rectangular profile whereby the cross-sectional constriction or constrictions is or are formed on an internal circumferential wall of the rectangular profile and thus project into the inner bore of the glass tube. Thus, when sealing in functional elements into the glass tube's face side the distance to be covered by the respective tube wall to form a hermetic encapsulation is shorter by comparison with a circular or rectangular profile which leads to lower glass stresses on sealing or encapsulation of the functional elements in glass tubes according to the invention.

In this case continuous contours which project into the glass tube's inner bore are preferably used as cross-sectional constriction. Especially low-stress glass to metal fusions can be achieved according to the invention in that the relevant cross-sectional constriction is formed as a convex meniscus projecting inwards. As will be explained below in greater detail, such menisci form automatically and almost free from stress if the glass tube is formed by casting a molten glass into an appropriate mould in which is disposed coaxially a shaping means appropriately specifying the inner profile of the glass tube, for example in the shape of a mandrel, over which the glass melt flows.

According to a further aspect of the present invention, two corresponding cross-sectional constrictions are provided each on opposing inner circumferential walls of the glass tube.

According to a further, also independently claimed aspect of the present invention, a glass tube for technical applications is provided, especially for electrical or magnetic components, with an inner bore which forms at least one inner edge that extends substantially in the longitudinal direction of the glass tube. In this case, the angle of curvature of the respective inner edge is at least less than or equal to 0.1 mm and preferably less than or equal to 0.03 mm. As will be explained subsequently in greater detail, such a glass tube with a comparatively angular inner profile may be formed by simply casting a molten glass into an appropriate mould in which is disposed coaxially a shaping means appropriately specifying the inner profile of the glass tube, for example in the shape of a mandrel, over which the glass melt flows. In this way it is possible to produce low-stress glass tubes with an angular inner and/or outer contour simply and cost-effectively. Such glass tubes are exceptionally suitable as technical glass tubes with non-round geometry within the framework of SMD (surface mounted devices). In particular, such glass tubes cannot roll away laterally in practice, for example due to a soldering process, and thus after being placed on a printed circuit board or the like are practically fixed in a suitable position. This production process is also especially suited to very special, close tolerance geometries, even with small and medium batch sizes, since it is possible to reduce the expenditure in order to achieve the geometry by appropriate selection of a mould.

According to a further aspect of the present invention that can also be claimed independently, a glass tube for technical applications is further provided, especially for electrical or magnetic components and especially of the type as described above, which is characterised in that the glass tube is produced from a preform by means of a conventional redrawing process.

Since the geometry of the glass tube remains practically unchanged during redrawing and only the outside diameter is reduced with the ratio of outside diameter to wall thickness essentially unchanged, it is already possible on the basis of the preform's geometry to precisely specify the glass tube's geometry after redrawing.

On the whole, glass tubes with any inner and outer profile which can also basically be further processed prior to redrawing, for example by grinding or the like in the cold condition, are suitable as preforms. Preforms as defined by the invention may, for example, be produced directly from the melt by means of a drawing process (for example using a Vello, Danner or downdraw process) or may be produced by means of an extrusion process, deposition process or by means of another known process for the production of preforms. However, according to the invention in this case it is preferable to use a glass tube as described above as the preform for a conventional redrawing process.

According to a further preferred aspect of the present invention, the preform in this case is, however, produced by casting a molten glass into a suitable mould which is preferably shaped as a vertical shaft extending in the direction of the force of gravity or as a cavity extending longitudinally with a small ratio of opening width to length, with the result that the outer profile of the glass tube is determined by the mould or the shaft, whereby a shaping means, for example in the shape of a mandrel, extending coaxially is provided inside the mould or the shaft over which the molten glass flows, with the result that the inner profile of the glass tube is determined by the shaping means, whereby the shaping means is cooled so that the molten glass solidifies to a glass tube in the mould or in the shaft.

In this case the molten glass may be cast directly into the shaft at a temperature corresponding to a viscosity less than 10^{7.5} dPas, preferably with a viscosity ranging from 10 dPas to 10⁵ dPas and even more preferably with a viscosity ranging from 10² dPas to 10⁵ dPas, i.e. significantly lower than in the conventional drawing processes mentioned previously. Preferably the molten glass is cast directly into the shaft whilst forming a free meniscus. In this case the molten glass is cooled down on the shaping means to a temperature below the softening temperature of the glass with the result that the glass tube supports the afterflowing molten glass in a manner that appropriately prevents said afterflowing molten glass from flowing through the shaft in an uncontrolled manner.

It is thus possible, in a simple and inexpensive manner, to form advantageously homogeneous and precise glass tubes with comparatively high wall thicknesses, as the wall thickness when casting the glass tube according to the invention is no longer limited by the bulb and the drawing parameters of conventional drawing processes.

According to a preferred aspect of the present invention, it is in particular possible to form a glass tube for use as a preform with a ratio of outside diameter (OD) to wall thickness (WT) which is less than or equal to 0.1*OD/[mm], wherein OD and WT are to represent the outer diameter (OD) and the wall thickness (WT) respectively of the glass tube in millimetres in each case. Here the outer diameter of the glass tube may be greater than or equal to 40 mm.

Since surface tension effects have less influence and flow dynamic effects are of considerably less significance when casting the glass tube by comparison with drawing the glass tube from a glass melt, new geometries for glass tubes are accessible according to the invention at low production costs. These include in particular geometries with sharp corners and geometries with particularly distinctive convex cross-sectional constrictions on the inside, for example in the shape of menisci or indentations. For whilst drawing processes directly from the melt are bound to a comparatively low drawing viscosity of around 10⁵ dPas for example, it is also possible with casting of the glass tube or the preform from a molten glass preferred according to the invention to use other viscosities. In particular lower viscosities (e.g. 10³ dPas) lend themselves here to the casting process as then it is possible to achieve particularly good filling of the mould.

By contrast, other correlations are applicable for drawing processes. With the comparatively low viscosities, compared with redrawing processes, such as are used in conventional drawing processes (for example Vello, Danner or downdraw processes), the glass can still be deformed extremely easily. Unlike with casting processes, the excellent deformability results here in the glass attempting to assume a minimum surface (circular cross-section). Sharp edges are therefore considerably rounded, even if they are provided in the die or needle geometry. Moreover, indentations inwards on the inside of the tube are deformed to a greater extent outwards with the result that they form a largely circular inner space. In contrast to this, glass tubes with sharp corners and cross-sectional constrictions projecting evenly inwards, for example in the shape of indentations, can also be formed reliably and with low stress using the process according to the invention for the production of a glass tube as viscosities of >10⁵ dPas—preferably even >10⁷ dPas—are usable for the redrawing step. Thus with the process according to the invention, it is possible, by comparison with the process of drawing from the melt, to select preferably especially low viscosities for the casting process and especially high viscosities for the redrawing process in order to obtain a glass tube according to the invention.

According to a further aspect of the present invention, direct contact of the molten glass with an inner circumferential wall of the shaft and/or with an outer circumferential wall of the shaping means or mandrel is prevented during the casting process by the formation of a gas cushion on the inner circumferential wall of the shaft and/or the outer circumferential wall of the shaping means or mandrel. This is in contrast to the known conventional processes of drawing glass tubes from a glass melt in which there is always a direct and usually adhesive contact with a drawing die and an inner needle. As a result of this, conventionally a characteristic speed profile is created due to the glass cross-section with minima at the contact points to the needle and the die, whereby the speed profile changes significantly after exiting from the die. As a result of this complex flow movement, in the conventional processes of drawing from the glass melt there arise significant deviations between the geometry of the glass tube and the geometry of the die even disregarding surface tension effects. With direct casting according to the invention such complicated flow movements do not arise, with the result that the glass tube or the preform can be produced advantageously with precise geometry both simply and inexpensively.

Furthermore, it is advantageous that the usual sometimes costly design of the die geometry in a conventional drawing process is no longer necessary in order to comply with close specifications. Thus, according to the invention, it is possible to achieve almost any internal geometries for the glass tube or preform in this manner, especially also comparatively narrow edge radii and very defined inner indentations inwards.

In principle it is impossible using the process according to the invention to achieve any geometries of the inner bore for the glass tube or preform, especially also inner bores with a non-round geometry. Whilst the outer geometry of the glass tube or preform substantially matches the inner geometry, if the glass tube is rotated during casting or drawing, it is of course also possible to cast or draw the glass tube or preform without rotation in which case the outer profile of the glass tube or preform can deviate from the inner profile. In this way it is possible according to the invention to form glass tubes or preforms with any inner and/or outer profile.

In particular it is possible in this way to achieve a preform or a glass tube with a non-uniform wall thickness. As previously explained, the contours of the preform will largely match the contours of the glass tube after the redrawing process. As a result, optimisation cycles may be superfluous in the production of the glass tubes according to the invention since there may be present a defined relationship between the prefabricated casting mould for example and the preform (tube from which the glass tube is later created) and then between the glass tube produced.

For the redrawing process, the preform may be clamped in a retaining device, it may be partially heated or heated in sections and then drawn to a glass tube with the desired diameter.

### SUMMARY OF THE FIGURES

The invention is illustrated in greater detail in the following on the basis of embodiments which are illustrated schematically in the Figures. In this case the same reference numbers in the individual Figures describe the same elements or elements having the same effect. The Figures show:

FIG. 1 a cross-section of a first embodiment of a glass tube according to the invention with pronounced inner indentation X;

FIG. 2 a cross-section of a further embodiment of a glass tube according to the invention with inner rectangle and defined edge radius r; and

FIG. 3 a schematic view of a device for producing a preform for the production of a glass tube according to the present invention by means of a redrawing process.

### DETAILED DESCRIPTION OF PREFERRED EXAMPLARY EMBODIMENTS

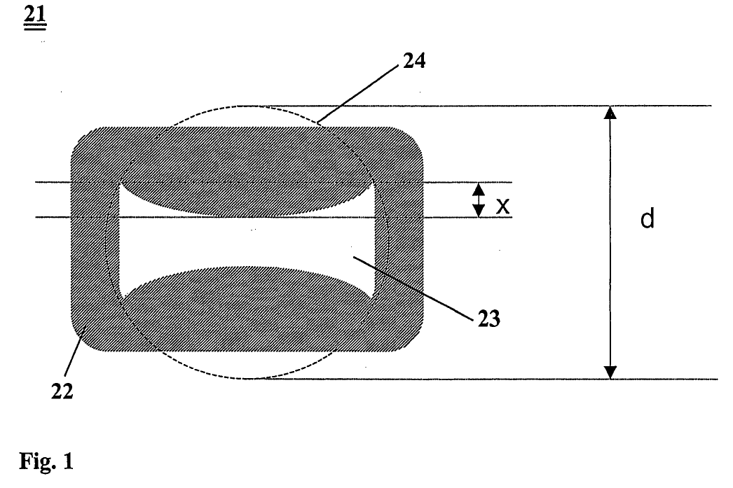

According to FIG. 1, glass tube 21 has a substantially rectangular-shaped outer profile which is formed from four tube walls. The two lateral tube walls in the embodiment illustrated are flat and extend substantially parallel to each other over the entire height of glass tube 21. The opposing upper and lower tube walls have a cross-sectional constriction on their respective inner circumferential wall which narrows inner bore 23 of glass tube 21.

According to FIG. 1, the two corresponding cross-sectional constrictions are formed as convex bulges projecting inwards in the shape of menisci. In the direction of the width of glass tube 21, the cross-sectional constrictions have a continuous, smooth course. The cross-sectional constrictions cut the two side walls at respective corner points of inner bore 23 or of the inner profile. These four corner points define circumference 24 marked schematically by a dotted line, the diameter of which is designated with the variable d. As can be seen clearly from FIG. 1, all inner circumferential walls of glass tube 21 lie within circumference 24 thus defined. This highlights the considerable deviation from the usual circular geometry of the inner bore of conventional reed tubes.

According to FIG. 1, the cross-sectional constrictions are disposed on two opposing inner circumferential walls of glass tube 21. The present invention is not, however, restricted to this special geometry. Rather it is possible for only one cross-sectional constriction to be provided on a single inner circumferential wall or cross-sectional constrictions may be formed on more than two inner circumferential walls.

The size x in FIG. 1 designates the distance by which the respective cross-sectional constriction projects into inner bore 23 relative to the base line (indicated by the upper unbroken line) defined by the associated corner points.

According to the present invention, glass tube 21 is formed in such a way that the following relationship between inner indentation X and diameter d of the circumference is fulfilled: X greater than or equal to 0.02*d. Even more preferable in this case, the following relationship is fulfilled according to the invention: X greater than or equal to 0.1*d.

If corresponding cross-sectional constrictions or indentations are also present on both lateral walls of glass tube 21, then according to the invention corresponding relationships can be fulfilled for these cross-sectional constrictions or indentations.

Overall the cross-section of inner bore 23 is thus considerably reduced which renders it significantly more easy to carry out low-stress sealing of function elements in glass tubes, such as is necessary for example in the case of electrical or magnetic components, such as reed switches for example, under a shielding gas atmosphere or under vacuum conditions.

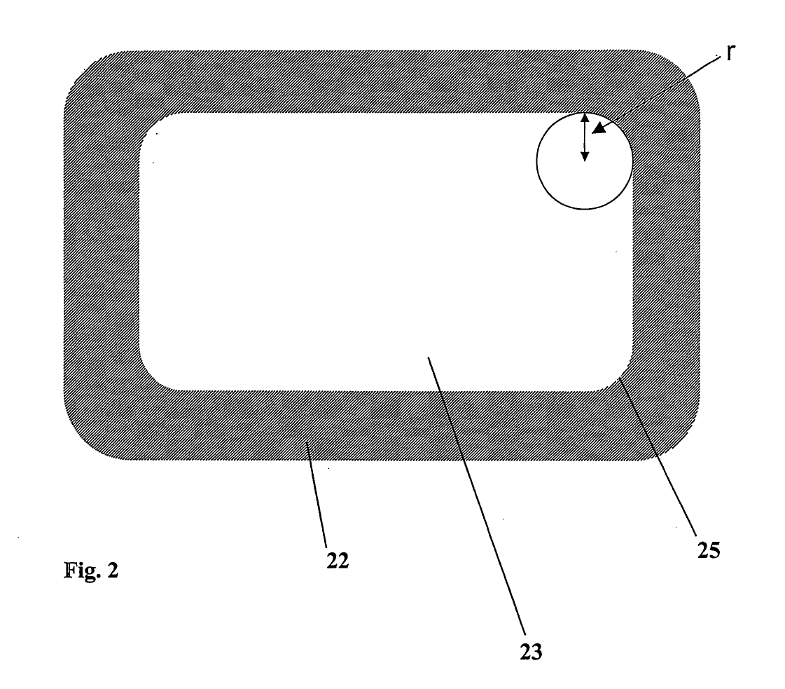

FIG. 2 shows a glass tube according to a second embodiment of the present invention. According to FIG. 2, the glass tube has a substantially rectangular inner and outer profile, wherein the inner circumferential walls are formed substantially flat and running parallel to each other, i.e. without cross-sectional constrictions as described previously in FIG. 1. The circle in this case indicates the inner radius r of inner edges 25 of inner bore 23.

According to the second embodiment, the radius of curvature r of inner edge 25 is less than or equal to approximately 0.1 mm and even more preferably less than or equal to approximately 0.03 mm.

Naturally, it is also possible to produce glass tubes according to the present invention which combine the features previously described on the basis of FIGS. 1 and 2.

The glass tubes according to the invention may be used for any technical applications, for example as sheath tubes for reed switches or reed relays or as sheath tubes for similar electrical or magnetic components.

According to a further embodiment of the present invention, a glass tube as previously described on the basis of FIGS. 1 and 2 is used as a preform, i.e. as preformed, hollow starting material for a subsequent redrawing process for the production of glass tubes with smaller outside diameters. It is known that in a conventional redrawing process, the ratio of outside diameter to wall thickness cannot be substantially reduced whilst the outside diameter can be significantly reduced. According to a further embodiment, it is also possible to set a different OD/WT ratio (outside diameter to wall thickness) by means of a pressure difference between the inside of the tube and the outside of the tube.

For redrawing, the cast tube is clamped in a retaining device, partially heated and then drawn to the desired outside diameter.

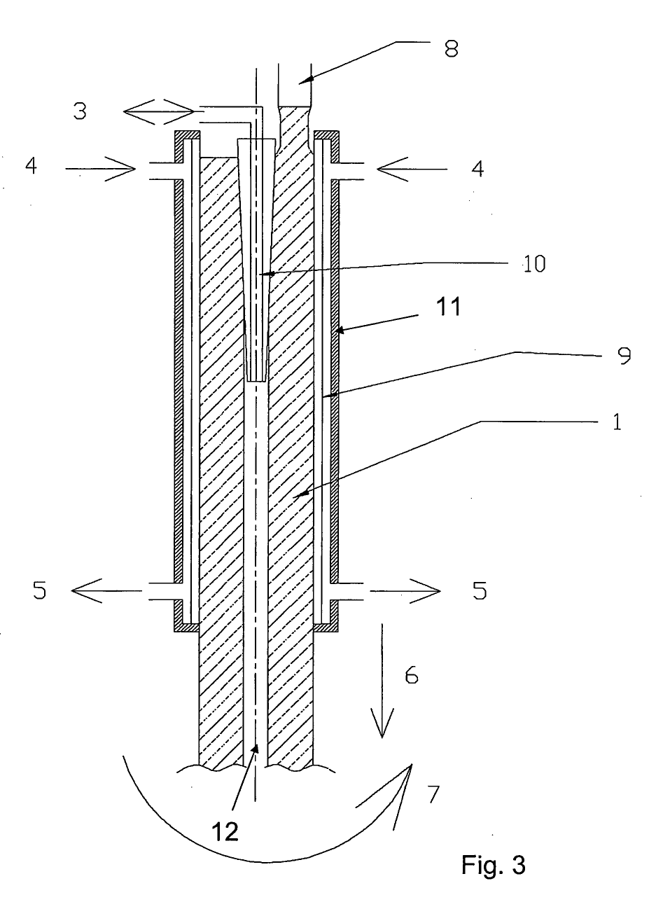

In the following, a preferred process according to the present invention for the production of a glass tube to be used as a preform for the redrawing process described previously will be described on the basis of FIG. 3. In this case FIG. 3 shows a cross-section of an embodiment of the device according to the invention for the production of glass tubes.

According to FIG. 3, the device comprises an elongate and comparatively slender shaft 9 and a mandrel 10 acting as a shaping means which is located in the interior of the shaft and extends coaxially with shaft 9. Shaft 9 extends vertically, i.e. in the direction of the force of gravity. The shaft wall preferably comprises a material which is stable under high temperatures, for example graphite, white metal, SiC and/or steel.

According to FIG. 3, shaft 9 is held in a pressure vessel 11, so that a flushing gas can be held in the annular gap between shaft 9 and the inner circumferential wall of pressure vessel 11 in order to surround shaft 9.

A coaxial and concentric mandrel 10, which acts as a shaping means for determining the inner profile of glass tube 1 is introduced into shaft 9 centrally from the top. Mandrel 10 can be removed from shaft 9, for example to start up the device. Mandrel 10 preferably comprises a material which is stable under high temperatures, such as, for example, graphite, white metal, SiC and/or steel or is formed from this. It is particularly preferable for mandrel 10 to be a graphite mandrel. A coolant flows coaxially through mandrel 10. Coolants may be, for example, a gas, a liquid such as water or a gas-liquid mixture.

According to FIG. 3, the mandrel is of a slightly conical construction, with the lower or downstream diameter being smaller than the upper or upstream diameter. If the cone is too small, there may be a risk of the glass shrinking onto the mandrel and the process having to be stopped. The circumferential wall of shaft 9 may contain a porous material, so that the flushing gas can pass from the interior of pressure vessel 11 through the circumferential wall of shaft 9 in order to form a gas cushion on the inner circumferential wall of shaft 9. The formation of a gas cushion by means of a porous wall material is described, for example, in U.S. Pat. No. 4,546,811, the content of which is to be explicitly included in the present application by reference. Porous material within the meaning of the invention may be porous graphite, porous metal, porous ceramics and other porous materials which are resistant to high temperatures.

According to one embodiment, the gas cushion prevents direct contact between the glass or glass tube and the shaft material. The gas cushion is preferably formed with an overpressure. For this purpose flushing gas can flow continuously via flushing gas inlets 4 into pressure vessel 11 and flushing gas outlets 5 can be at least partly blocked, so that a certain overpressure is generated in pressure vessel 11 and is transmitted through the circumferential wall of shaft 9 to the gas cushion.

Shaft 9 may in principle assume any shape. Shaft 9 is preferably conical or cylindrical. In the case of a cylindrical shaft a glass tube with a circular outer profile is therefore formed.

According to FIG. 3, the molten glass is introduced into shaft 9 from a melting channel, a melting tank or a comparable vessel or glass feed means (not illustrated) through a die 8 at the upper edge of shaft 9. As represented schematically in FIG. 3, the molten glass can be cast freely directly into shaft 9, so that a free meniscus can be formed below die 8 and at the upper edge of shaft 9. The process is preferably carried out at the highest possible temperature in order to suppress cooling waves. However the temperature should also not be too high, as the glass is then not sufficiently solid after being removed from the mould and may be further deformed following shaping.

When it is cast into shaft 9 the glass melt is preferably at a temperature which corresponds to a viscosity of 10-10⁵ dPas, preferably 10² to 10⁵ dPas, and is therefore lower than a viscosity of approximately 10^{7.5} dPas, which corresponds to a softening temperature of the glass. The low viscosity glass melt evenly fills the annular gap between shaft 9 and mandrel 10 which leads to a very homogeneous glass quality. As the glass is drawn off in the direction of the force of gravity and thus parallel to the walls of shaft 9, the glass tube can be produced substantially free from stresses.

In order to start the process, a starter (not shown), which is adapted in terms of shape to the glass tube, may be used, this acting as a flat closure element for temporarily closing shaft 9. This starter can be clamped in a rotation and displacement mechanism such that it projects into the shaft from below. This starter prevents the glass from flowing through the shaft without filling said shaft at the beginning of the process, for example when the device is started up.

As soon as a sufficient glass film has formed on the starter, this is continuously lowered, so that the rising meniscus of the glass remains as constant as possible. As soon as the glass tube is of a sufficient length to be taken up from the feed and rotation mechanism, the starter can be removed, for example drawn out to the side. The process can then be operated continuously. In this case glass tube 1 passes through shaft 9 in the feed direction which is indicated by arrow 6, i.e. preferably in the direction of the force of gravity. For this purpose it is not absolutely necessary to draw the glass out of shaft 9, as is known from the prior art, even though drawing, for example to accelerate the process, can of course be used. As indicated by arrow 7, where circular geometries are concerned, glass tube 1 may also be continuously rotated about its longitudinal axis while the shaping described above is carried out.

During the production process glass continuously flows out of the feed pipe, which communicates with the die 8, onto the glass tube or rotating glass tube. The continuously produced tube can then be cut into segments of the desired length.

When using the process which is described here the glass passes through the temperature range which is critical for crystal formation and crystal growth in a very short time. It is therefore also possible to produce tubes from readily crystallising glasses, i.e. from glasses with a high tendency towards crystallisation, with this process.

The application of the process is not restricted to circular cross-sectional geometries. For example, tubes of a rectangular or oval or any desired cross-sectional shape can also be produced using this process. However in this case the glass tube should not be rotated.

In this respect it is necessary to ensure during the process that the cross section of the shaft acting as a mould is filled as completely and uniformly as possible. This can also be achieved where non-circular cross-sectional shapes are concerned by giving the feeder or die 8 an appropriate shape or by a rotational and translatory movement of shaft 9 and cast tube 1.

For further details of the device and the production process, reference is made to co-pending U.S. patent application of the applicant claiming priority of German patent application no. 102004060408.8 filed on Dec. 14, 2004 and having the title ‘Device and process for producing a glass tube’, the content of which for disclosure purposes is to be explicitly included in the present application by reference.

As indicated by the exemplary measuring point which is represented in FIG. 2 by the triangle, the process according to the invention enables glass tubes with OD/WT ratios of lower than approximately 0.1*OD/[mm] to be obtained, wherein OD and WT represent, in the convention introduced above on the basis of FIG. 2, magnitudes which indicate the outside diameter (OD) and the wall thickness (WT), respectively, of the cast glass tube in millimetres. Further series of tests carried out by the inventors, which are not represented in FIG. 2 for reasons of clarity, have confirmed this observation.

The glass tubes which are produced with this device are particularly suitable for use as preforms (appropriately preshaped starting materials) for producing tubes of a smaller diameter by means of an additional redrawing process. In this case a different OD/WT ratio (outside diameter to wall thickness) can also be set by means of a pressure difference between the inside of the tube and the outside of the tube.

Tubes with a smaller OD and an OD/WT ratio which is greater than or equal to the corresponding ratio of the preform can be produced from the tubes thus produced in a subsequent redrawing step. In order to achieve this, the cast glass tube is clamped in a retaining device, partially heated and then drawn to the desired diameter OD. The ratio OD/WT does not as a rule change as a result. However the ratio OD/WT can be influenced by pressurisation in the interior of the tube. It is thus possible, for example, to produce a glass tube with an OD/WT ratio which is greater than or equal to 0.1*OD/[mm] from a preform with OD/WT<0.1*OD/[mm] by means of an internal pressure pi which is higher than the external pressure pa.

### Examplary Embodiment

A conical graphite mandrel (outside diameter (OD) top=23 mm, OD bottom=18 mm) is introduced centrally into a slightly conical graphite shaft (inside diameter (ID) top=71 mm, ID bottom=72 mm) around which argon flushes. The graphite mandrel is mounted on a coaxially cooled holder of special steel. This is cooled by a mixture of air and atomised water. The SCHOTT 8250 glass is melted in a precious metal crucible. A precious metal pipe, which can be heated, is welded to the bottom of the crucible, this pipe opening into a die, which can also be separately heated. The parameters which are shown in Table 1 are set when the shaft is filled with the glass 8250. The results are represented in Table 2. A temperature of 1230° C. proves to be of advantage for the glass 8250 described in this example.

The tubes which are thus obtained are redrawn in a redrawing system. In this respect the outside diameter OD and the ratio OD/WT are set by means of the internal pressure and the drawing speed.

In a further exemplary embodiment the preform tube is produced as above. These are redrawn in a redrawing system. A new OD/WT ratio for the drawn tubes is set by means of the internal pressure. The product is then further shaped by means of two rolls in the deformation zone to form a rectangular tube. The rolls consist of hexagonal white metal or graphite in order to prevent damage to the surface of the glass tube.

TABLE 1
Parameters

| | | Test no. | | | | | |
|---|---|---|---|---|---|---|---|
| | | 1 | 2 | 3 | 4 | 5 | 6 |
| Crucible | ° C. | 1180 | 1180 | 1180 | 1180 | 1180 | 1180 |
| Tube | ° C. | 1130 | 1150 | 1180 | 1200 | 1210 | 1230 |
| Die | ° C. | 900 | 920 | 950 | 970 | 980 | 1000 |
| Air (mandrel) | l/min | 150 | 150 | 150 | 150 | 150 | 150 |
| Water (mandrel) | l/min | 4 | 4 | 1.75 | 1.75 | 1.75 | 1.75 |
| Rotation Starter/ | rev/min | 1.8 | 3.75 | 3.75 | 7.5 | 7.5 | 10 |
| glass tube | | | | | | | |

TABLE 2
Results

| | | Test no. | | | | | |
|---|---|---|---|---|---|---|---|
| | | 1 | 2 | 3 | 4 | 5 | 6 |
| Weight | g | 1622 | 1931 | 2005 | 3326 | 3675 | 3135 |
| Length | mm | 216 | 254 | 265 | 480 | 475 | 408 |
| OD max | mm | 69.4 | 69.5 | 69.6 | 69.6 | 69.7 | 67.9 |
| OD min | mm | 69.2 | 69.1 | 69.4 | 68.9 | 68.8 | 69 |
| ID (top) | mm | 23.9 | 22.4 | 24.6 | 21 | 21 | 20.8 |
| ID (bottom) | mm | 22 | 22.9 | 23.5 | 22.6 | 22 | 22.2 |
| WT(top) max | mm | 23.2 | 23.7 | 22.7 | 24.1 | 24.4 | 24 |
| WT(top) min | mm | 22.8 | 23.4 | 22.4 | 23.8 | 24.2 | 23.7 |
| WT(bottom) max | mm | 23.7 | 23.5 | 23 | 23.6 | 24.2 | 23.9 |
| WT(bottom) min | mm | 23.5 | 23.2 | 22.7 | 23.4 | 25 | 23.3 |
| Depth of cooling | mm | 1 | 0.6 | 0.2 | not | not | not |
| waves external* | | | | | measurable | measurable | measurable |
| Spacing of cooling | mm | 12.1 | 6.5 | 8.2 | 3.6 | 4.4 | 2.8 |
| waves external* | | | | | | | |
| Surface* | obscured/ | lustre | lustre | lustre | in the centre | in the centre | in the centre |
| | lustrous | | | | obscured, | obscured, | obscured, |
| | | | | | otherwise | otherwise | otherwise |
| | | | | | lustre | lustre | lustre |

Basically the process according to the invention is suitable for any grades of glass. However, for technical applications in which function elements are to be sealed in a glass tube, glass grades with a comparatively high absorbency coefficient are preferred for infrared light used for sealing or encapsulation, for example for light in the wavelength range between approximately 700 nm and approximately 4000 nm. Such glass grades are described for example in EP 1 153 895 A1 and U.S. Pat. No. 4,277,285 the content of which is to be explicitly included in the present application by reference.

In the following, a process for the production of a preform according to the present invention will be described further.

With the process a molten glass is cast into a shaft 9 in order to define the outer profile of glass tube 1 wherein the molten glass flows over a shaping means 10 extending coaxially in the interior of the shaft in order to define the inner profile of glass tube 1 and wherein shaping means 10 is cooled so that the glass melt solidifies into glass tube 1 in the shaft.

With this process, the molten glass can flow freely into shaft 9 so that the shaft is completely filled at least in sections with the molten glass in order to define the outer profile of glass tube 1.

With this process, the molten glass can be cast into shaft 9 at a temperature which corresponds to a viscosity of less than 10^{7.5} dPas, more preferably a viscosity in the range between 10 dPas to 10⁵ dPas and even more preferably a viscosity in the range between 10² dPas to 10⁵ dPas, whereby the molten glass is cooled on shaping means 10 to below the softening temperature of the glass so that glass tube 1 supports the glass subsequently flowing into the shaft.

With the process, a gas cushion can be formed on an inner circumferential wall of shaft 9 in order to prevent a direct contact between the inner circumferential wall of shaft 9 and an outer circumferential wall of glass tube 1, at least in sections. In this case the gas cushion may be formed on the inner circumferential wall of shaft 9 with an overpressure. Moreover, with the process it is also possible to set the overpressure of the gas cushion by feeding a flushing gas into a pressure vessel 11 holding shaft 9.

With the process at least one flushing gas outlet 5 of pressure vessel 11 can be at least partly closed in order to create this overpressure of the gas cushion.

With the process, the flushing gas may pass through a circumferential wall that is formed at least in sections from a porous material into the interior of the shaft in order to generate the overpressure of the gas cushion.

With the process, a coolant 3 can flow through and cool shaping means 10 in order to guarantee that the molten glass cools sufficiently quickly, i.e. on the lower edge or in the immediate vicinity of the shaping means.

With the process, a flushing gas can pass through an outer circumferential wall of shaping means 10 that is formed at least in sections from a porous material, in order to form a gas cushion, which is preferably subject to an overpressure, between an inner circumferential wall of glass tube 1 and an outer circumferential wall of shaping means 10 and to prevent direct contact between the inner circumferential wall of glass tube 1 and the outer circumferential wall of shaping means 10, at least in sections.

The process can also include the step of axially lowering a closure element which is adapted to a shape of glass tube 1 and removal of the closure element from the shaft after the lowering step.

With the process, a glass tube can be formed for use as a preform as defined by this application so that a ratio of outside diameter (OD) to wall thickness (WT) is less than or equal to 0.1*OD/[mm], wherein OD and WT denote the outside diameter and the wall thickness respectively of glass tube 1 in millimetres and wherein the outside diameter is greater than or equal to 40 mm. Such glass tubes cannot be produced using the previously mentioned conventional drawing processes for drawing a glass tube from a glass melt.

A glass tube 1 cast in such a manner is thus used according to the invention as a preform wherein the outside diameter of cast glass tube 1 is reduced by means of an additional redrawing step.

On redrawing, cast glass tube 1 can be clamped in a retaining device, partially heated and then drawn to the desired outside diameter.

In this case lateral forces may act on the glass in the deformation zone during redrawing and give rise to a change in the cross-sectional shape. Here the lateral forces may be applied by one or more rollers.

What is claimed is:

1. Glass tube for encapsulating electrical or magnetic components, said glass tube having an inner bore and at least one cross-sectional constriction, wherein the relationship applicable between the respective cross-sectional constriction x and the diameter d of the circumference of the inner bore is: x≧0.02*d.

2. The glass tube according to claim 1 wherein for the relationship between the respective cross-sectional construction x and the diameter d of the circumference of the inner bore the relationship applicable is: x≧0.1*d.

3. The glass tube according to claim 1 wherein the inner bore has a substantially rectangular cross-section whereby corners of the substantially rectangular cross-section define the circumference and whereby the cross-sectional constrictions are formed as convex menisci projecting inwards on opposing tube walls.

4. The glass tube for encapsulating electrical or magnetic components, said glass tube having an inner bore with at least one inner edge, wherein the radius of curvature of the respective inner edge is less than or equal to 0.1 mm.

5. The glass tube according to claim 4 wherein the radius of curvature of inner edge is less than or equal to 0.03 mm.

6. The glass tube according to claim 5 wherein the glass tube is a sheath tube for reed switches.

7. The glass tube according to claim 1, wherein the glass tube is produced from a preform by way of a redrawing process.

8. The glass tube according to claim 7 wherein the preform is produced by means of a casting process.

9. The glass tube according to claim 8 whereby in the casting process molten glass is poured or cast into a shaft of a device in the interior of which is located a shaping means, especially a mandrel, for defining the inner bore.

10. The glass tube according to claim 9 whereby in the casting process direct contact of the molten glass with an inner circumferential wall of the shaft and/or with an outer circumferential wall of the shaping means or mandrel is prevented by the formation of a gas cushion on the inner circumferential wall of the shaft and/or on the outer circumferential wall of the shaping means or mandrel.

11. The glass tube according to claim 7, said preform having a non-round geometry.

12. The glass tube according to claim 7, said preform having non-uniform wall thickness.

13. The glass tube according to to claim 7, said preform having preform matches the glass tube in contours.

14. The glass tube according to to claim 7, wherein a throughput greater than 1 kg/h is worked with during redrawing.

15. The glass tube according to claim 7 wherein the redrawing process includes the following steps:
a) clamping of the preform in a retaining device;
b) partial heating of the preform; and
c) drawing of the preform to a glass tube with the desired diameter.

16. The glass tube according to claim 7 said glass tube being a sheath tube for reed switches.

17. Process for the production of a glass tube for encapsulating electrical or magnetic components, wherein the glass tube is produced from a preform by way of a redrawing process.

18. The process according to claim 17, during which the preform is produced by means of a casting process.

19. The process according to claim 18, during which in the casting process molten glass is poured or cast into a shaft of a device in the interior of which is located a shaping means, especially a mandrel, for defining the inner bore.

20. The process according to claim 19, during which in the casting process direct contact of the molten glass with an inner circumferential wall of the shaft and/or with an outer circumferential wall of the shaping means or mandrel is prevented by the formation of a gas cushion on the inner circumferential wall of the shaft and/or on the outer circumferential wall of the shaping means or mandrel.

21. The process according to claim 17 during which the preform is produced with a non-round geometry.

22. The process according to claim 17 during which the preform is formed with a non-uniform wall thickness.

23. The process according to claim 17 during which the preform is formed in such a way that the preform matches the glass tube in contours.

24. The process according to claim 17 wherein a throughput greater than 1 kg/h is worked with during redrawing.

25. The process according to claim 17 during which the redrawing process includes the following steps:
a) clamping of the preform in a retaining device;
b) partial heating of the preform; and
c) drawing of the preform to a glass tube with the desired diameter.

26. The process according to claim 17 during which the glass tube is formed with an inner bore d and at least one cross-sectional constriction x in such a way that the relationship applicable between the respective cross-sectional constriction s and the diameter d of the circumference of inner bore is: x greater than or 0.02*d, more preferably x greater than or equal to 0.1*d.

27. The process according to claim 26, wherein the glass tube is formed in such a way that the inner bore has a substantially rectangular cross-section, that corners of the substantially rectangular cross-section define the circumference and that the cross-sectional constrictions are formed as convex menisci projecting inwards on opposing tube walls.

28. The process according to claim 17, in which the glass tube is formed with an inner bore with at least one inner edge so that the radius of curvature of the respective inner edge is less than or equal to 0.1 mm, more preferably less than or equal to 0.03 mm.

29. The process according to claim 17, said glass tube being a sheath tube for reed switches.

30. Use of the glass tube according to claim 1 in a reed switch.

31. Preform for the production of glass tubes for technical applications, especially electrical or magnetic components, for use in the processes according to claim 17, said preform being formed as a glass tube with an outer diameter and a wall thickness, wherein the ratio of outer diameter to wall thickness is less than or equal to 3 wherein the outer diameter is greater than or equal to 50 mm.
